(19) United States
(12) Patent Application Publication
(10) Pub. No.: US 2006/0127710 A1
(43) Pub. Date: Jun. 15, 2006

(54) System and method for bypassing failed stacks in a multiple stack fuel cell

(76) Inventor: Juergen Schulte, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/088,566

(22) Filed: Mar. 24, 2005

Related U.S. Application Data
(60) Provisional application No. 60/636,314, filed on Dec. 15, 2004.

(51) Int. Cl. H01M 8/00; H01M 8/10

(52) U.S. Cl. 429/13; 429/30

(57) ABSTRACT

A system and a method that isolates and bypasses a failed fuel cell stack that is one of a plurality of connected fuel cell stacks within a fuel cell. By isolating and/or bypassing a failed fuel cell stack the fuel can continue to generate power in a degraded mode of operation. The switching required for isolation and/or bypassing can be performed by switches that are manually, electrically, electromagnetically, or hydraulically actuated.

### CROSS-REFERENCE TO RELATED APPLICATIONS

This application claims the benefit of U.S. Provisional Application 60/636,314 filed Dec. 15, 2004 under 35 U.S.C. 119(e).

### FIELD OF THE INVENTION

The field of the invention relates to the use of a fuel cell for providing electrical DC power directly from a fuel and oxidizer without going through an internal combustion process.

### BACKGROUND OF THE INVENTION

A fuel cell consists of multiple cells stacked together to form a “stack”. The number of cells per stack is determined by the desired output voltage and the processing limitations of the fuel flow within the stack. To obtain higher power two or more stacks can be connected in series to obtain higher voltages and two or more stacks can be connected in parallel to obtain higher current flows, or there could be a combination of series and parallel connections of multiple stacks.

The failure of one or more stacks within a multiple stack fuel cell results in the failure of the fuel cell. Furthermore, a single stack failure could cause other stacks to also fail. Thus, a need exists to prevent the failure of a stack in a multi-stack fuel cell from causing other stacks to fail and from causing the fuel cell to fail.

### SUMMARY OF THE INVENTION

The present invention involves a system and a method for isolating a failed fuel stack that is connected with one or more other stacks in a high-power fuel cell. For series connected stacks, switches are placed between each fuel cell stack that can route the electrical connection around the failed stack. Depending on the voltage of each stack and the acceptable voltage range of the electrical load on the fuel cell, this invention switches the fuel cell electrical connection around one or more failed stacks to maintain the fuel cell operation in a fail-safe degraded mode.

For parallel connected stacks, switches are placed in series with each fuel cell stack that simply break the connection to the failed stack. The embodiment of the switching function can use either diodes or relays for an electrically controlled switch, or a mechanical device that can manually make and break the connection.

Another aspect of the invention includes a system of bypassing failed stacks within a fuel cell having a plurality of fuel cell stacks connected in at least one of a series connection and a parallel connection. The system includes means for at least one of electrically isolating and bypassing a failed fuel cell stack, and means for making an electrical connection around a failed fuel cell stack that is connected in series to one or more other fuel cell stacks.

In an implementation of the aspect of the invention described immediately above, the invention may include one or more of the following. The fuel cell includes a fuel cell enclosure that the system is located within. The fuel cell includes a fuel cell enclosure that system is located external to. The one or more mechanical manually operated switches are used for at least one of electrical isolation and bypassing. The one or more contactor relay electrically operated switches are used for at least one of electrical isolation and bypassing. The one or more high-current contactor diode switches are used for electrical bypassing. The fuel cell is a Proton Exchange Membrane (PEM) fuel cell. The fuel cell fuel is at least one of a compressed hydrogen gas an a liquid hydrogen fuel cell. The fuel cell is a solid oxide fuel cell. The fuel cell includes solid oxide pellet fuel. The fuel cell includes an oxidizer that is at least one of ambient air, filtered air, heated air and cooled air. The fuel cell includes an oxidizer that is at least one of compressed oxygen and liquid oxygen. The system further includes one or more manually actuated valves that turn off a fuel supply of a failed fuel cell stack. The system further includes one of one or more electrically actuated valves and one or more hydraulically actuated valves that turn off a fuel supply of a failed fuel cell stack. The system further includes manually actuated valves that turn off an oxidizer supply of a failed fuel cell stack by one or more manually actuated valves. The system further includes at least one of one or more electrically actuated valves and one or more hydraulically actuated valves that turn off an oxidizer supply of a failed fuel cell stack. The fuel cell is used in a mobile application located on or in at least one of a land vehicle, a water vehicle, an air vehicle, and a space vehicle for propulsion power. The fuel cell is used in a mobile application located on or in at least one of a land vehicle, a water vehicle, an air vehicle, and a space vehicle for auxiliary power. The fuel cell is used in a fixed application to provide DC power as at least one of a main power supply and a backup power supply. The fuel cell is used in a fixed application to provide AC grid power as at least one of a main power supply and a backup power supply.

A further aspect of the invention involves a method of bypassing failed stacks within a fuel cell having a plurality of fuel cell stacks connected in at least one of a series connection and a parallel connection. The method includes at least one of electrically isolating and bypassing a failed fuel cell stack, and making an electrical connection around a failed fuel cell stack that is connected in series to one or more other fuel cell stacks.

In an implementation of the aspect of the invention described immediately above, the invention may include one or more of the following. The method occurs within a fuel cell enclosure. The method occurs external to the fuel cell enclosure. At least one of electrically isolating and bypassing occurs with at least one of an one or more electrically operated switches and one or more mechanical manually operated switches. At least one of electrically isolating and bypassing occurs with one or more contactor relay electrically operated switches. Electrical bypassing occurs with one or more high-current contactor diode switches. The fuel cell is a Proton Exchange Membrane (PEM) fuel cell. The fuel cell fuel is at least one of a compressed hydrogen gas fuel cell and a liquid hydrogen fuel cell. The fuel cell is a solid oxide fuel cell. The fuel cell fuel includes solid oxide pellets. The fuel cell includes an oxidizer that is at least one of ambient air, filtered air, heated air, and cooled air. The oxidizer is at least one of compressed oxygen and liquid oxygen. The method further includes turning off a fuel supply of a failed fuel cell stack by one or more manually actuated valves. The method further includes turning off a fuel supply of a failed fuel cell stack by at least one of one or more electrically actuated valves and one or more hydraulically actuated valves. The method further includes turning off an oxidizer supply of a failed fuel cell stack by manually actuated valves. The invention turns off an oxidizer supply of a failed fuel cell stack by at least one of one or more electrically actuated valves and one or more hydraulically actuated valves. The fuel cell is used in a mobile application located on or in at least one of a land vehicle, a water vehicle, an air vehicle, and a space vehicle for propulsion power. The fuel cell is used in a mobile application located on or in at least one of a land vehicle, a water vehicle, an air vehicle, and a space vehicle for auxiliary power. The fuel cell is used in a fixed application to provide DC power as at least one of a main power supply and a backup power supply. The fuel cell is used in a fixed application to provide AC grid power as at least one of a main power supply and a backup power supply. The failure is determined by a programmed algorithm in a digital processor controller and an analog processor controller. The method further includes switching algorithm programmed into at least one of a digital processor controller and an analog processor controller that in turn commands the switching process.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a block diagram of an embodiment of a system for isolating and bypassing a failed fuel cell stack of a plurality of series connected fuel cell stacks of a fuel cell.

FIG. 2 is a block diagram of another embodiment of a system for isolating and bypassing a failed fuel cell stack of parallel connected fuel cell stacks of a fuel cell.

FIG. 3A is a simplified block diagram of an embodiment of a fuel cell powered system that incorporates the system for isolating and bypassing a failed fuel cell stack.

FIG. 3B is a simplified block diagram of an embodiment of a fuel cell powered vehicle that incorporates the system for isolating and bypassing a failed fuel cell stack.

FIG. 4A is a block diagram of an embodiment of a fuel cell bypass switch using two high-current contactor relays in a two stack fuel cell.

FIG. 4B is a block diagram of an embodiment of fuel cell bypass switch using two high-current contactor diodes in parallel with two fuel cell stacks.

FIG. 5 is a block diagram circuit schematic of an embodiment of the invention within a fuel cell powered bus. The switching is embodied in the contactor relays, K1 through K6.

### DETAILED DESCRIPTION OF A PREFERRED EMBODIMENT

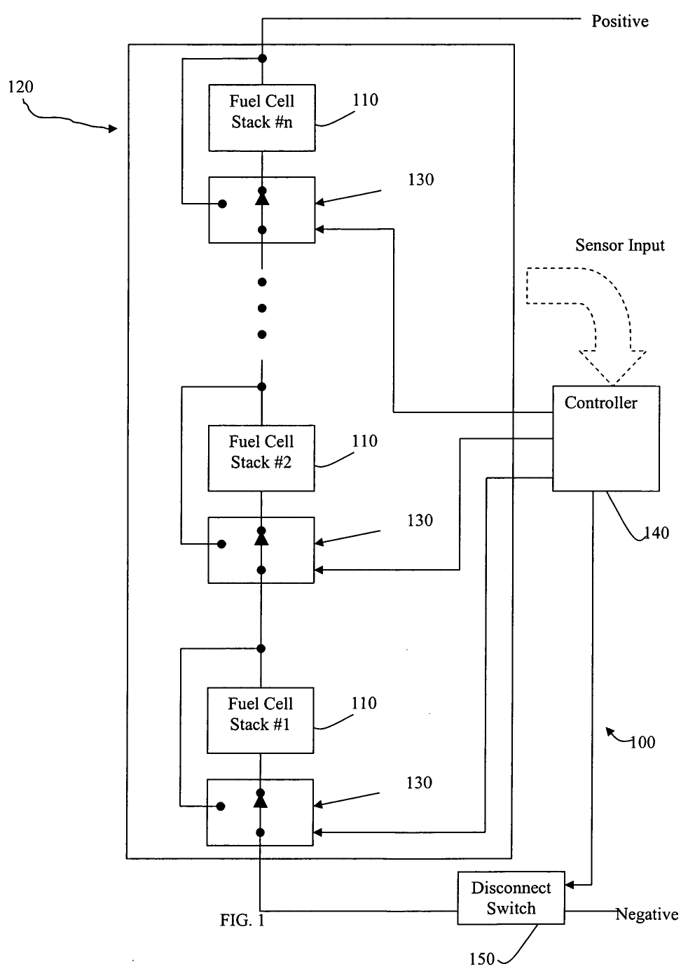

With reference to FIG. 1, an embodiment of a system 100 and a method that isolates and bypasses a failed fuel cell stack 110, which is one of a plurality of series connected fuel cell stacks 110 within a fuel cell 120, will now be described. By isolating and/or bypassing a failed fuel cell stack 110 the fuel cell 120 can continue to generate power in a degraded mode of operation.

The switching required for isolation and/or bypassing can be performed by bypass switching devices 130 that are manually, electrically, electromagnetically, or hydraulically actuated. As will be discussed in more detail below, mechanical switches, electromechanical relays, and high-current contactor diode semiconductor devices are examples of switching devices that can be used in this application. High-current contactor diodes are used in switching applications that require repetitive cycles that would quickly wear out a mechanical relay. The automatic switching characteristics of diodes can be used to improve the operational reliability of the fuel cell.

The fuel cell 120 illustrated in FIG. 1 is a series connected multiple stack fuel cell 120 with a separate bypass switching device 130 for each stack 110. Sensor input from one or more sensors (e.g., voltage sensor, current sensor, temperature sensor, flow sensor, pressure sensor) is received by the controller 140 and the controller 140 determines if a single stack 110 has had a failure (or the fuel cell 120 has failed) and, if so, causes the bypass switching device 130 to bypass a failed stack 110 for continued fuel cell operation (or if the entire fuel cell is determined to have failed, the controller 140 may communicate with a disconnect switch 150 to break or open the fuel cell electrical connection). The fuel cell output would lose the voltage supplied by the failed stack 110 but could continue to operate in a degraded mode. In addition to damage protection of the fuel cell 110, the controller 140 may use the sensor data for operation and status reporting.

In addition to not having to break open a fuel cell electrical connection in the event of a failed stack condition, by being able to bypass a failed stack 110, this invention gives the fuel cell designer and the system designer more flexibility in the design choices to increase the reliability of the fuel cell power source.

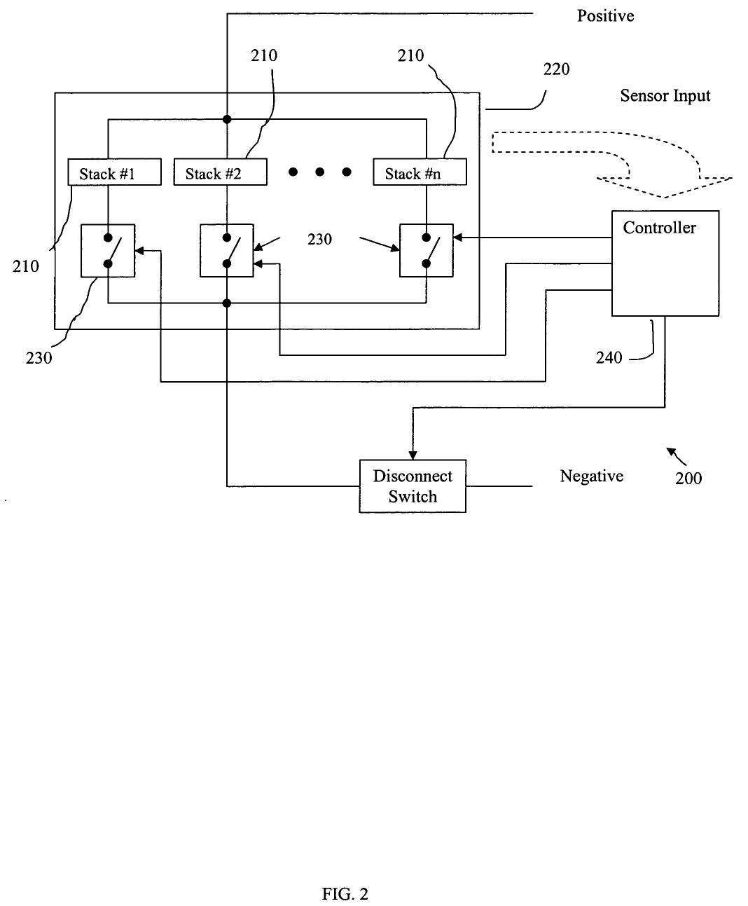

With reference to FIG. 2, another embodiment of a system 200 and a method that isolates and bypasses a failed fuel cell stack 210, which is one of a plurality of parallel connected fuel cell stacks 210 within a fuel cell 220, will now be described. The block diagram depicts a parallel connected multiple stack fuel cell 220 with a cutoff switching device 230 for each stack 210. The configuration of FIG. 2 illustrates the system 200 and method of the invention that allows a controller 240 to determine if a single stack 210 has had a failure and cutoff the failed stack 210 for continued fuel cell operation. The fuel cell output would lose the current supplied by the failed stack 210 but could continue to operate in a degraded mode. In addition to not having to break open a fuel cell electrical connection in the event of a failed stack condition, by being able to bypass a failed stack 210 this invention gives the fuel cell designer and the system designer more flexibility in the design choices to increase the reliability of the fuel cell power source.

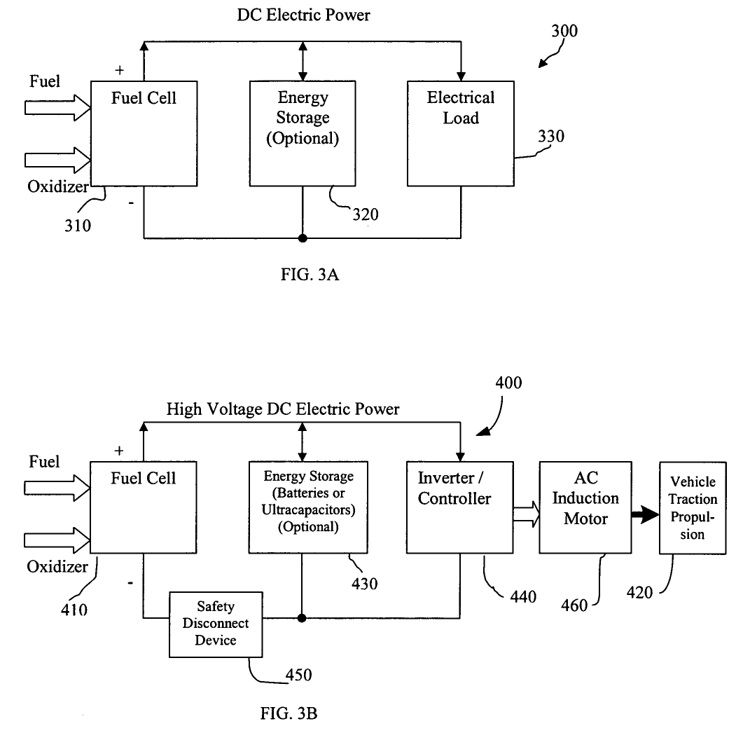

With reference to FIG. 3A and FIG. 3B, embodiments of fuel cell powered systems 300, 400 that include either or both of the systems 100, 200 for isolating a failed stacked in a multiple stack fuel cell will now be generally described.

FIG. 3A illustrates an embodiment of a fuel cell powered system 300 including one or more fuel cells 310, one or more optional energy storage units 320, and one or more electrical loads 330. The one or more fuel cells 310 receive fuel and oxidizer and produce DC electric power by the fuel cell 310. The optional energy storage unit(s) 320 may store excess power generated. The generated and/or stored power drives the one or more electrical loads 330.

FIG. 3B illustrates another embodiment of a fuel cell powered system 400 where the fuel cell powered system 400 is a fuel cell powered vehicle. One or more fuel cells 410 essentially power the motor vehicle through vehicle traction propulsion 420. The system 400 may also include one or more optional energy storage units 430 (e.g., batteries, ultracapacitors), an inverter/controller 440, a safety disconnect device 450, and an AC induction motor 460. The one or more fuel cells 410 receive fuel and oxidizer to supply DC electric power. The storage unit(s) 430 may store excess power generated. The generated and/or stored power is converted to AC power to power the AC induction motor 460, which drives the vehicle traction propulsion 420. The safety disconnect device 450 may disconnect the fuel cell 410 if the fuel cell 410 is determined to have failed.

If inverter/controller 440 is a Siemens DUO Inverter the input voltage limits are nominally 101 to 700 volts DC. A vehicle 120 kilowatt fuel cell would probably have multiple stacks to reach an output voltage range of 350 volts DC to 650 volts DC. One application uses a DC-to-DC converter at the output of the fuel cell 410 to make the voltages more compatible. The DC input voltage range of inverters and DC-to-DC converters is approaching or beyond a 2:1 ratio. If at least two stacks are used, bypass switching of a failed stack would provide for more operation reliability. Typical fuel cell stacks may be more in the range of 70 to 100 volts for more fuel cell efficiency. Therefore, if more, smaller stacks are electrically connected together along with the bypass switching, fuel cells could be designed to withstand a stack failure without severe consequences.

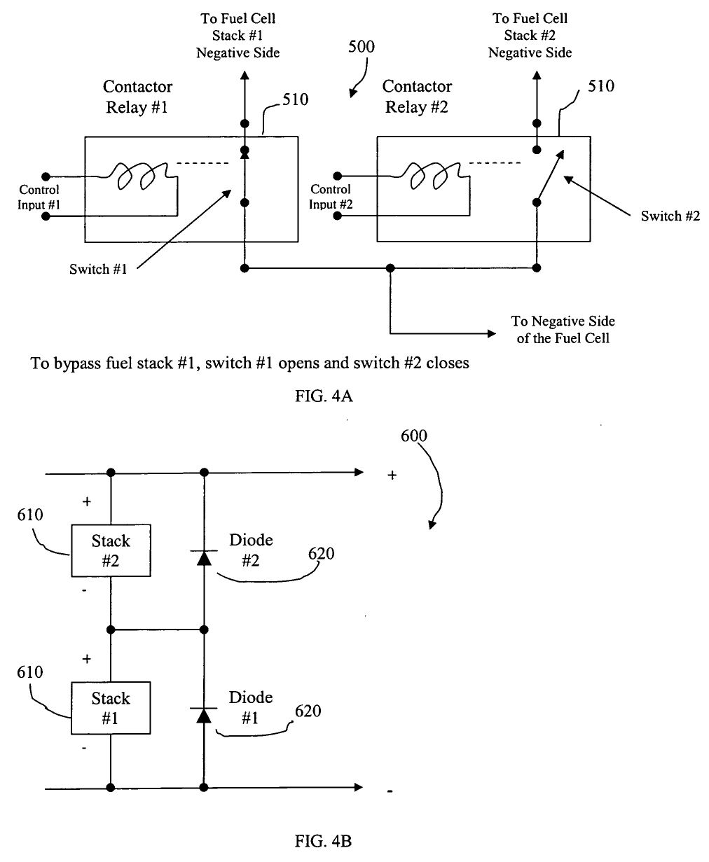

With reference to FIG. 4A, the diagram illustrates an embodiment of a series stack connected bypass switch circuit 500 using high-power relays 510 (e.g., contactors). A single contactor 510 per fuel cell stack would embody a switch for parallel connected stacks.

With reference to FIG. 4B, the diagram illustrates an embodiment of a series connected bypass switch circuit 600 using a diode 620 in parallel with each fuel cell stack 610. The diode 620 has the characteristic that when connected in parallel with the fuel cell stack 610 under normal operation the diode 620 is biased in the “off” condition and does not conduct, but, if a fuel cell stack 610 fails in the open condition or is switched out of the circuit 600, the diode 620 is biased “on”, by the remaining fuel cell stacks 610, and conducts current to bypass the failed fuel cell stack 610. Each fuel cell stack 610 may include other safety sensing and switching devices not shown in the diagram.

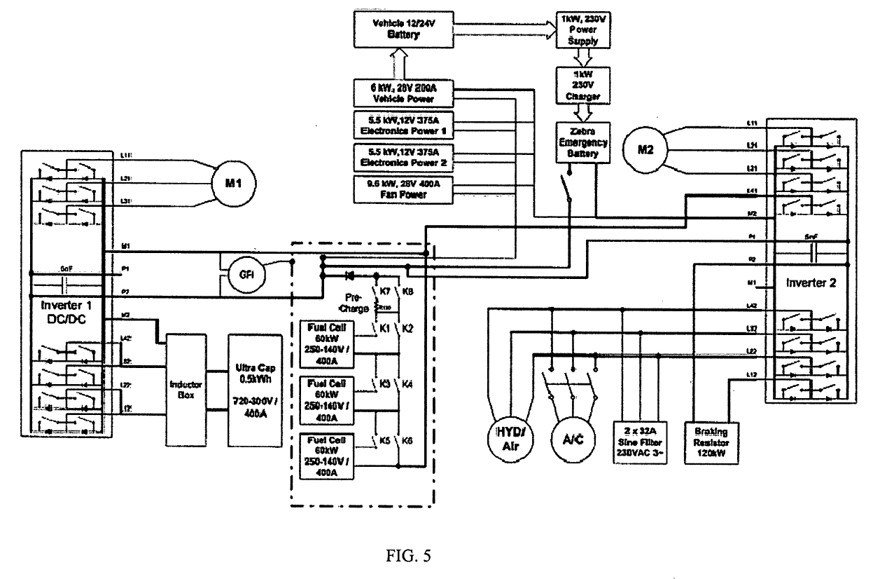

With reference to FIG. 5, the diagram illustrates another embodiment of the invention and depicts the major system components of a fuel cell powered hybrid-electric drive system for an urban transit bus. A 180 kW fuel cell is outlined in the middle of the diagram and includes three series-connected 60 kW fuel cell stacks. Contactor relays K1 through K6 embody bypass switches, two for each fuel cell stack. Contactors K7 and K8 along with the diode and resistor implement a connection to the high-power distribution buss. By bypassing failed stacks, in a degraded mode any one of the fuel cells has sufficient voltage to drive the motors M1 and M2 through half of DUO Inverter1 and half of DUO Inverter 2, respectively.

It will be readily apparent to those skilled in the art that still further changes and modifications in the actual concepts described herein can readily be made without departing from the spirit and scope of the invention.

What is claimed is:

1. A method of bypassing failed stacks within a fuel cell having a plurality of fuel cell stacks connected in at least one of a series connection and a parallel connection, comprising:
at least one of electrically isolating and bypassing a failed fuel cell stack,
making an electrical connection around a failed fuel cell stack that is connected in series to one or more other fuel cell stacks.

2. The method of claim 1, wherein the method occurs within a fuel cell enclosure.

3. The method of claim 1, wherein the method occurs external to the fuel cell enclosure.

4. The method of claim 1, wherein at least one of electrically isolating and bypassing occurs with at least one of an one or more electrically operated switches and one or more mechanical manually operated switches.

5. The method of claim 1, wherein at least one of electrically isolating and bypassing occurs with one or more contactor relay electrically operated switches.

6. The method of claim 1, wherein electrical bypassing occurs with one or more high-current contactor diode switches.

7. The method of claim 1, wherein the fuel cell is a Proton Exchange Membrane (PEM) fuel cell.

8. The method of claim 1, wherein the fuel cell fuel is at least one of a compressed hydrogen gas fuel cell and a liquid hydrogen fuel cell.

9. The method of claim 1, wherein the fuel cell is a solid oxide fuel cell.

10. The method of claim 1, wherein the fuel cell fuel includes solid oxide pellets.

11. The method of claim 1, wherein the fuel cell includes an oxidizer that is at least one of ambient air, filtered air, heated air, and cooled air.

12. The method of claim 1, wherein the oxidizer is at least one of compressed oxygen and liquid oxygen.

13. The method of claim 1, further including turning off a fuel supply of a failed fuel cell stack by one or more manually actuated valves.

14. The method of claim 1, further including turning off a fuel supply of a failed fuel cell stack by at least one of one or more electrically actuated valves and one or more hydraulically actuated valves.

15. The method of claim 1, further including turning off an oxidizer supply of a failed fuel cell stack by manually actuated valves.

16. The method of claim 1, wherein the invention turns off an oxidizer supply of a failed fuel cell stack by at least one of one or more electrically actuated valves and one or more hydraulically actuated valves.

17. The method of claim 1, wherein the fuel cell is used in a mobile application located on or in at least one of a land vehicle, a water vehicle, an air vehicle, and a space vehicle for propulsion power.

18. The method of claim 1, wherein the fuel cell is used in a mobile application located on or in at least one of a land vehicle, a water vehicle, an air vehicle, and a space vehicle for auxiliary power.

19. The method of claim 1, wherein the fuel cell is used in a fixed application to provide DC power as at least one of a main power supply and a backup power supply.

20. The method of claim 1, wherein the fuel cell is used in a fixed application to provide AC grid power as at least one of a main power supply and a backup power supply.

21. The method of claim 1, wherein the failure is determined by a programmed algorithm in a digital processor controller and an analog processor controller.

22. The method of claim 1, further including a switching algorithm programmed into at least one of a digital processor controller and an analog processor controller that in turn commands the switching process.
